(19) United States
(12) Patent Application Publication
(10) Pub. No.: US 2026/0048350 A1
(43) Pub. Date: Feb. 19, 2026

(54) CONNECTION HEAD FOR A FILTER CANDLE, AND INSTALLATION SYSTEM

(71) Applicant: BWT Holding GmbH, Mondsee (AT)

(72) Inventors: Jürgen JOHANN, Mondsee (AT); Anton MAIRHOFER, Zell Am Moos (AT); Andrea PAVAN, Cittadella PD (IT)

(73) Assignee: BWT Holding GmbH, Mondsee (AT)

(21) Appl. No.: 19/101,881

(22) PCT Filed: Aug. 3, 2023
(86) PCT No.: PCT/EP2023/071529

§ 371 Date: Feb. 6, 2025

(30) Foreign Application Priority Data
Aug. 11, 2022 (DE) 10 2022 120 306.9

(51) Int. Cl. B01D 35/147; B01D 29/56; B01D 29/60; B01D 35/143

(52) U.S. Cl. CPC B01D 35/147; B01D 29/56; B01D 29/603; B01D 29/606; B01D 35/143; B01D 2201/302

(57) ABSTRACT

The disclosure relates to a connection head for a filter candle, comprising a housing having an inlet and an outlet and a connection portion for the filter candle. A bypass is provided inside the housing, which can be opened and closed again by an actuator, in particular a magnetic actuator, which extends into the housing.

### CROSS-REFERENCE TO RELATED APPLICATION

This application is a national stage application, filed under 35 U.S.C. § 371, of International Patent Application PCT/EP2023/071529, filed on Aug. 3, 2023, which claims the benefit of German Patent Application DE 10 2022 120 306.9, filed on Aug. 11, 2022.

### TECHNICAL FIELD

The disclosure relates to a connection head for a filter candle for treating drinking water and to an installation system comprising a connection head.

### BACKGROUND

Filter candles are known for the treatment of drinking water, they are installed in a connection head, in particular screwed into it.

Such a connection head may, for example, be installed in an on-site water pipe. The water flows through the filter candle thereby undergoing water treatment.

Usually, the filter candle is used not so much to filter out suspended matter but more to treat the water, in particular to remove pollutants and germs and/or to soften the water.

This type of system is simple in design and the filter candle can be easily exchanged when it is exhausted and replaced with a new filter candle.

Such a system is known, for example, under the trade name BWT Bestmax.

Published patent application DE 10 2020 128 216 A1 (inventors: Dr. Jürgen Johann, Andrea Pavan) discloses a water installation system which can, for example, comprise a filter candle with a filter candle head. According to the teachings of this document, it is suggested that the water to be treated is passed through a bypass which is only closed when required, using a remote control, so that the water will then flow through the filter candle.

Thus, a remote control can be easily used to dispense temporarily treated water. Once the tap is closed, the system automatically switches back to its initial state.

Such a system is particularly advantageous if water that has undergone a specific treatment step is only to be dispensed when desired. For example, the water to be treated can be passed through an ion exchanger in the basic state, which softens the water and reduces the solids dissolved in the water. Such soft water is particularly suitable for washing dishes and laundry and hardly forms any deposits when drying.

However, very soft water is not so suitable for drinking purposes, due to its low mineral content.

Therefore, when desired, a water treatment device can be activated using a remote control, which releases minerals into the water so that the latter will have an optimal composition for drinking purposes.

### SUMMARY

The disclosure is based on the object of providing a connection head for a filter candle which is optimized for such a system in which the water is intended to be passed through the filter candle only temporarily.

The object is achieved by a connection head for a filter candle and by an installation system equipped with this connection head as disclosed and claimed.

The disclosure relates to a connection head for a filter candle. The connection head comprises a housing having an inlet and an outlet.

The connection head is in particular designed to be installed inline in an existing on-site water pipe. For this purpose, the connection head may in particular have a mounting portion for being secured to a mounting bracket.

The connection head comprises a connection portion for a filter candle. The connection portion may in particular come in the form of a thread into which the filter candle is screwed by virtue of a complementary thread.

The disclosure relates in particular to a filter candle having an inlet and an outlet, which are designed as coaxially arranged passages. One passage can be provided centrally. An annular passage extends around the centrally arranged passage.

These passages can serve as the inlet and outlet of the filter candle. The connection head has complementary passages for being sealingly connected to the filter candle, i.e. in particular likewise a central passage around which an annular passage extends coaxially.

A bypass is provided inside the housing of the connection head, which can be opened and closed by an actuator that extends into the housing.

The inventors suggest to integrate a bypass in the head of the filter candle, which completely directs the water past the filter candle.

The bypass can be opened and closed by an actuator which is preferably installed in a separate housing on the outside of the housing of the connection head. In one direction, the opening or closing may be accomplished in an automatic manner, e.g. by virtue of a spring or by water pressure.

This provides for a simple and compact design. The connection head may be exchanged for a connection head known from the prior art, for example, and can thus provide a system in which the water treatment by the filter candle can be temporarily switched on and off.

The actuator comes preferably in the form of a magnetic actuator. For example, the actuator may comprise a plunger that extends into the housing of the connection head. The plunger can be moved by the magnetic actuator.

More particularly, the plunger can be moved by the magnetic actuator against a spring preload.

In this way, preferably, the bypass is temporarily closed by the magnetic actuator, so that water treatment takes place when the magnetic actuator is activated.

On the other hand, in the basic state the magnetic actuator can be de-energized. The water will then flow through the bypass and is not subjected to any water treatment.

Preferably, the connection head comprises a valve for the bypass and another valve in the flow path through the filter candle. Preferably, these valves are coupled to one another and are both switched by a single actuator.

More particularly, the valve for the bypass is opened by the actuator and at the same time the valve for the flow path through the filter candle is closed. This can be achieved, for example, by a coupling rod.

In a refinement, the connection head comprises an adjustable blending device.

A blending device is understood to be a device which allows to mix the water which is passed through a water treatment medium with water which is not passed through the water treatment system.

Such a blending device allows, for example, to adjust the hardness of the water or to adapt a water softening system to the local water hardness. A control element can be used to adjust the volume ratio between the water passed through the water treatment medium and the water not passed through the water treatment medium.

In the simplest case, the blending device may comprise a bypass through which a partial flow of the inlet water is directed, which is not passed through the filter candle.

Preferably, however, both partial flows are directed through the filter candle, but the partial flows enter the water treatment medium at different points.

For example, both partial flows can be passed through a medium for removing pollutants and/or germs, such as activated carbon, whereas one of the partial flows also passes through another water treatment medium, such as an ion exchanger.

In one embodiment, the actuator, when actuated, releases a check valve, also known as a non-return valve, which closes the bypass.

Thus, the check valve is open in the basic state. The actuator releases the blockage of the check valve, and the water will no longer flow via the bypass but through the filter candle.

Furthermore, according to one embodiment, the actuator is capable of driving a diaphragm valve, in particular release it when actuated.

More particularly, it is intended that both the bypass and the diaphragm valve are released by the actuator, so that in particular the bypass closes and the diaphragm valve opens.

The diaphragm valve opens a flow path that leads through the filter candle, while the check valve is closed at the same time.

Furthermore, according to a preferred embodiment, the diaphragm valve is opened through a check valve, in particular the check valve described above.

The actuator therefore only serves to release the diaphragm of the diaphragm valve, while the opening is achieved by the water pressure applied to the check valve, whereby the check valve closes at the same time.

In particular, the check valve may be coupled to the diaphragm valve via a rod. When the check valve is closed, the diaphragm valve is opened by virtue of the rod.

In one embodiment, the bypass and/or the actuator and/or the check valve are provided at the level of the inlet and the outlet.

Thus, these components are located in one plane, with the check valve and/or the diaphragm valve being arranged in particular adjacent to the connections for the filter candle in the housing.

According to a further aspect, the disclosure relates to a connection head for a filter candle. The connection head may in particular comprise the features described above.

The connection head comprises a housing having an inlet and an outlet and a connection portion for the filter candle, and a bypass is provided inside the housing. A respective flow meter is arranged in a bypass passage and in at least one of an inlet passage and an outlet passage.

The ratio of the flow rates allows to calculate the amount of water flowing through the filter candle. This is preferably taken into account for calculating the service life of the filter candle.

The flow meter can be better positioned in a bypass passage than in a passage that comes from the filter candle or leads to the filter candle. This is because the latter passage is preferably provided in the form of an annular passage.

The bypass passage provides a sufficiently long pipe section to place the flow meter, while at the same time maintaining a compact design.

The disclosure furthermore relates to an installation system which comprises the connection head described above.

For example, it is envisaged that the system comprises at least two connection heads, each one with a different filter candle, and with one of the filter candles comprising a different water treatment medium than the other filter candle.

In particular, one filter candle may contain means for releasing minerals, in particular magnesium, zinc and/or silicon. The water is temporarily passed through this filter candle in order to be enriched with minerals.

The filter candle may also be designed to soften the water, in particular by comprising an ion exchanger. Alternatively, the filter candle may come in the form of a reverse osmosis system.

Such a filter candle may also include other functionalities, such as disinfection using ozone or UV light.

In particular, it is intended that one filter candle serves to soften the water, while another filter candle, when operated temporarily, serves to produce water to be used for beverages.

The installation system preferably comprises a remote control for switching the actuator(s) of the connection head(s).

In particular, the remote control is capable of communicating wirelessly with the connection head.

The switching of the actuator may be taken into account in the calculation of the service life of the filter candle.

Preferably, the connection head together with the filter candle is installed below a tabletop, for example in the base cabinet of a kitchen.

The system preferably comprises a pressure sensor or flow meter and switches to the basic state when pressure increases, in which state the water does not flow through the filter candle.

It is in particular intended that the actuator is activated when the remote control is pressed, whereby the system switches to an active state in which the water flows through the filter candle.

The user can now open the tap and extract water for drinking purposes. When the user closes the tap, the pressure will increase, which can be detected by the pressure sensor, and the system will disable the actuator.

The pressure sensor may be installed inside the water pipe.

As an alternative to a pressure sensor, a flow meter may be used.

Furthermore, according to one embodiment, it is contemplated to install the pressure sensor in the filter head, in particular to integrate the pressure sensor at the inlet or outlet of the filter candle.

### BRIEF DESCRIPTION OF THE DRAWINGS

The subject-matter of the invention will now be explained in more detail with reference to the drawings of FIGS. 1 through 14 by way of an exemplary embodiment.

FIG. 1 is a perspective view showing a connection head.

FIG. 2 is a top plan view of the connection head.

FIG. 3 is a sectional view along line A-A of FIG. 2.

FIG. 4 is a cross-sectional view along line B-B of FIG. 3.

FIG. 5 is a detailed view of the area of the diaphragm valve and

FIG. 6 is a detailed view of the check valve.

FIG. 7 is a cross-sectional view with the bypass open.

FIGS. 8 and 9 show components of the diaphragm valve and of the check valve.

FIG. 10 is a schematic diagram of an installation system.

FIG. 11 is a sectional view by way of which the blending device shall be explained in more detail.

FIG. 12 is an illustration of an exemplary embodiment of a filter candle.

FIG. 13 is a cross-sectional view of a filter candle including a flow meter.

FIG. 14 is a longitudinal sectional view of a flowmeter.

### DETAILED DESCRIPTION

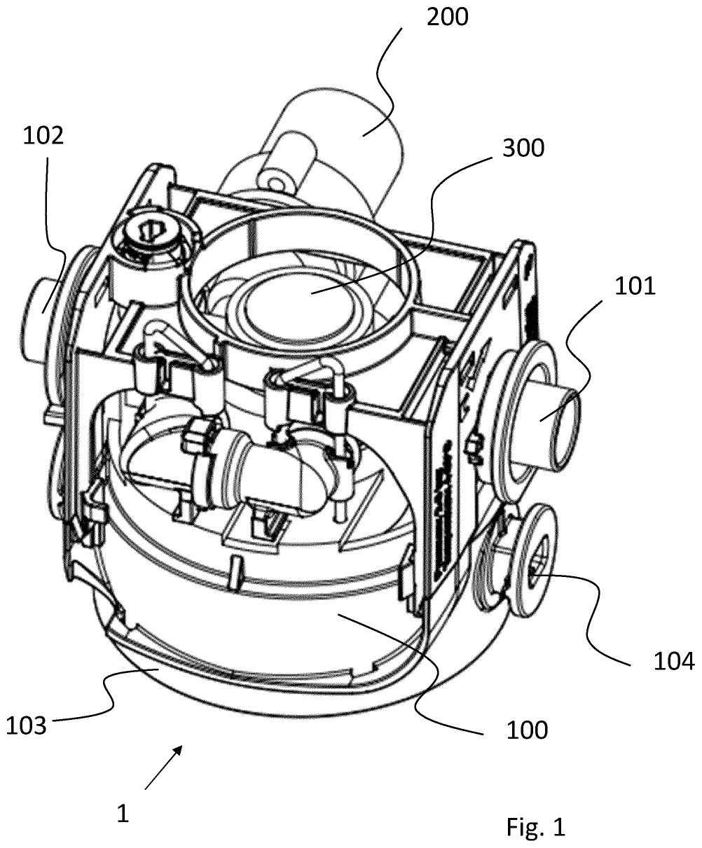

FIG. 1 is a perspective view showing a connection head 1 according to one exemplary embodiment.

The connection head 1 comprises a housing 100 having an inlet 101 and an outlet 102.

Inlet 101 and outlet 102 are provided on lateral sides of the housing 100 opposite to each other. This allows the connection head 1 to be installed inline in an existing on-site water pipe (not shown).

The housing 100 furthermore comprises a mounting portion 104 for securing the connection head 1 to a mounting bracket (not shown).

Furthermore, the housing 100 comprises a connection portion 103 in which a filter candle can be installed.

The filter candle is installed in the connection head from below, in particular screwed into the connection head which is attached to a wall.

Furthermore, the connection head 1 of this exemplary embodiment comprises a blending device 300. The blending device 300 allows to adjust a partial flow ratio of two flows that pass through the filter candle via different paths, for example by being equipped with a manually operable control element such as a rotatable setting member.

Furthermore, an actuator 200 is provided on a lateral side of the housing 100, which, as will be described in more detail below, closes a bypass that directs the water past the filter candle.

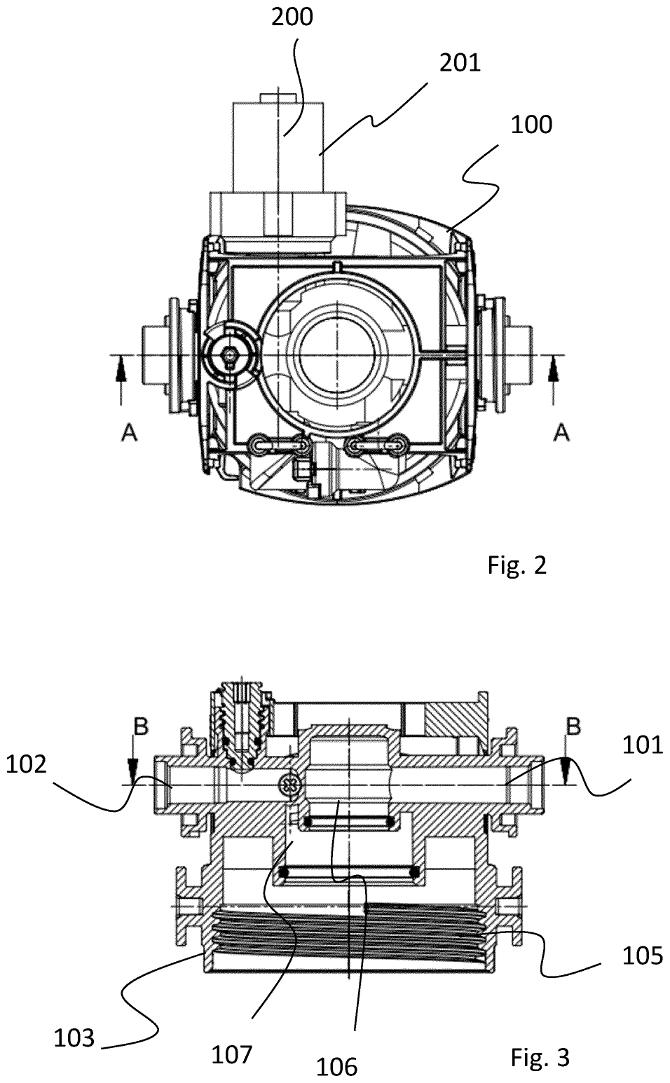

FIG. 2 is a top plan view of the connection head 1. The actuator 200 comprises a housing 201 which extends laterally from the housing 100 of the connection head 1.

FIG. 3 is a central longitudinal section along line A-A of FIG. 2.

Inlet 101 leads to an outlet 106 to the filter candle. The outlet 106 to the filter candle is arranged centrally in this exemplary embodiment.

An inlet 107 for the water flowing out of the filter candle is provided in the form of an annular passage which extends around the central outlet 106 to the filter candle.

The water which has passed through the filter candle flows through this annular passage 107 and through the outlet 102 towards the tap.

The connection portion 103 for the filter candle has a thread 105, which is in the form of an internal thread in this exemplary embodiment.

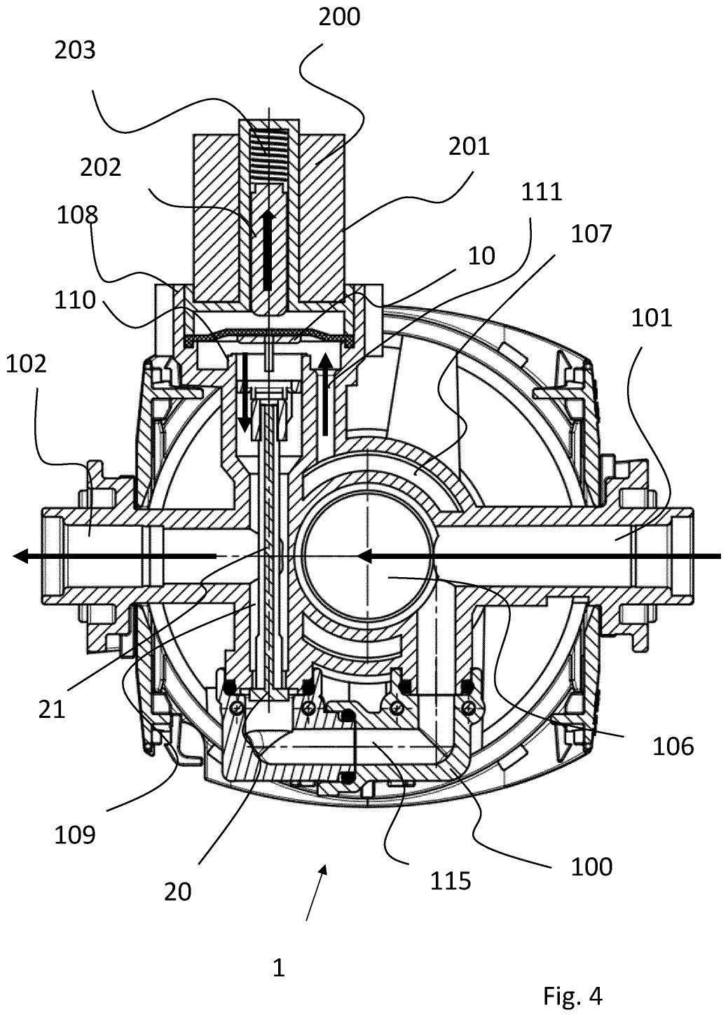

FIG. 4 is a cross-sectional view along plane B-B as shown in FIG. 3.

The cross-sectional view therefore cuts centrally through inlet 101 and outlet 102. The components for temporarily closing a bypass are arranged in this plane.

The housing 201 of magnetic actuator 200 is connected to a connection portion 108 of housing 100.

The actuator 200 comprises a plunger 202.

FIG. 4 shows the activated operation, i.e. the operating state in which the water flows through the filter candle.

In this operating state, the plunger 202 is retracted through magnetic force against the preload of the spring 203.

This releases the diaphragm 10 of a diaphragm valve.

A check valve 20 closes the passage 109 which leads to the outlet 102.

In this operating state, the water flows via inlet 101 to the outlet 106 and into the filter candle.

The water treated by the filter candle flows back into the connection head 1 via inlet 107 which is in the form of an annular passage.

Through passage 111, the water flows through the diaphragm valve including the diaphragm 10 and to the outlet 102.

The check valve 20, on the other hand, closes the passage 109, so that the bypass around the filter candle is closed.

Check valve 20 is coupled to the diaphragm 10 via rod 21. In this way, the check valve 20 will move the diaphragm 10 into the open position as illustrated here, when it is closed by the applied water pressure of the water flowing through passage 115.

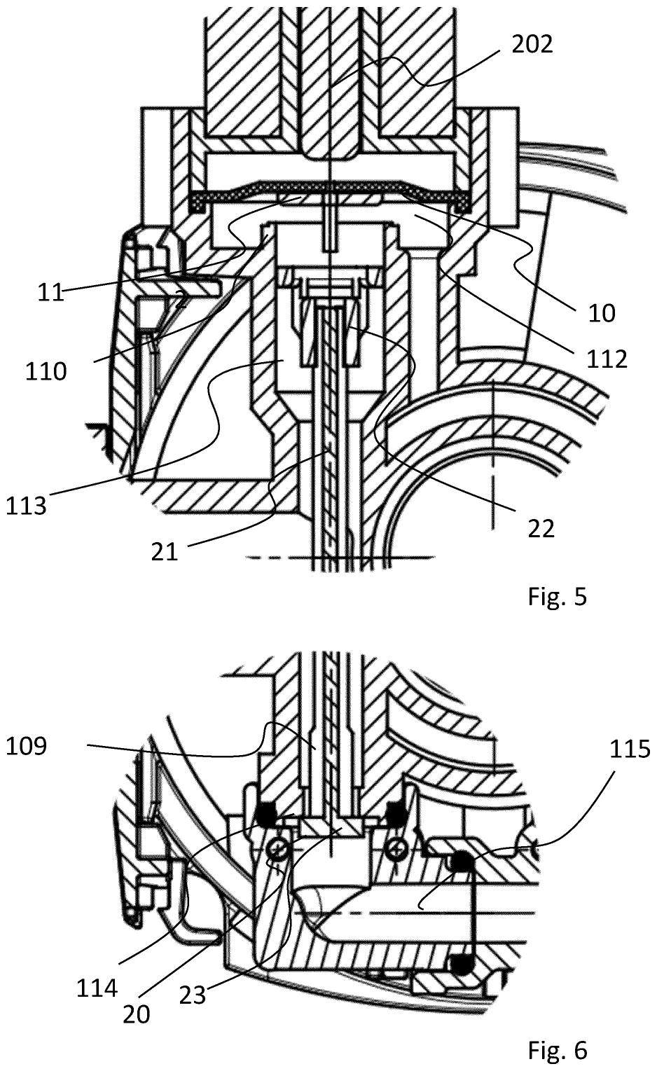

FIG. 5 is a detailed view of the area of the diaphragm valve.

The diaphragm valve comprises the diaphragm 10 which sits in the chamber 112.

The diaphragm 10 is lifted from its seat 110 along with a guide 11, so that the water can flow through the chamber 112.

When the plunger 202 is advanced, the diaphragm 10 is pressed onto the seat 110 thereby closing the diaphragm valve.

One end of the rod 21 is equipped with an end cap 22 which sits in the chamber 113.

On the opposite side, which is shown in FIG. 6, the check valve 20 comprises a plate 23 which engages on the seat 114.

The check valve is closed. The water cannot flow via passage 115 to passage 109 and thus to the outlet.

Rather, the water flows through the filter candle, as already explained in conjunction with FIG. 4.

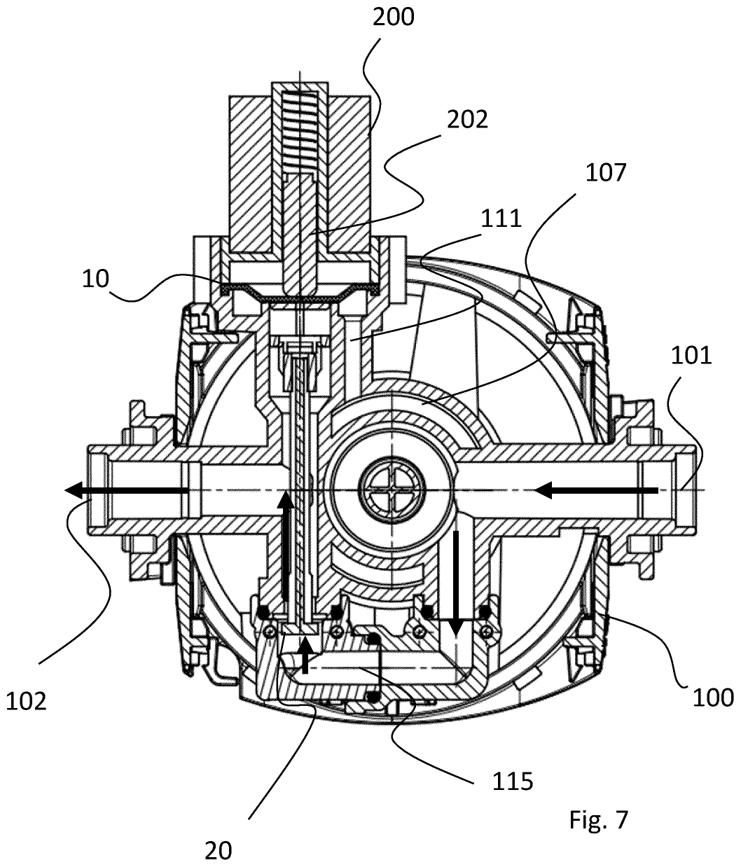

FIG. 7 shows the operating state when the actuator is not activated. The actuator 200 is now de-energized, so that the plunger 202 is pressed into the housing 100 by virtue of the spring (203 in FIG. 4).

The plunger 202 presses the diaphragm 10 onto its seat, and the water flowing out of the filter candle via inlet 107 and passage 111 can no longer flow to the outlet 102.

At the same time, the check valve 20 was opened by virtue of the rod 21, which is pressed into the passage 115 by the plunger.

In this operating state, the water now flows from the inlet 101 via passage 115 through the check valve 20 and to the outlet 102.

The water therefore no longer flows through the filter candle.

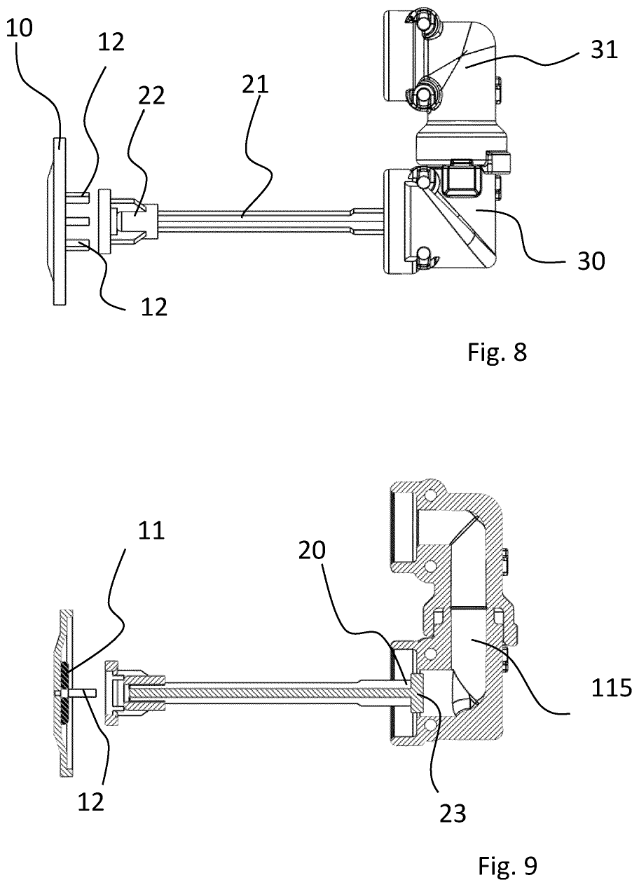

FIG. 8 shows components of the diaphragm valve and of the check valve. FIG. 8 is a side view, and FIG. 9 is a central sectional view.

The diaphragm 10 comprises a guide 11 which comprises spacers 12.

The spacers 12 may be arranged in a star-like pattern, for example, so that water can flow between the spacers.

The spacers 12 engage on the end cap 22 which is coupled to the rod 21.

Two connecting pieces 30, 31 are installed in the housing of the connection head.

The passage 115 which leads to the cover 23 of the check valve extends through the connecting pieces 30, 31.

When the actuator is not activated, the plunger presses the diaphragm 10 with the spacers 12 first onto the end cap 22. The cover 23 of the check valve 20 opens.

On the other hand, when the diaphragm 10 is released by activating the actuator, the water flowing through passage 115 will press against the cover 23 and the check valve will close.

This design means that no spring is required inside the water-carrying part of the connection head.

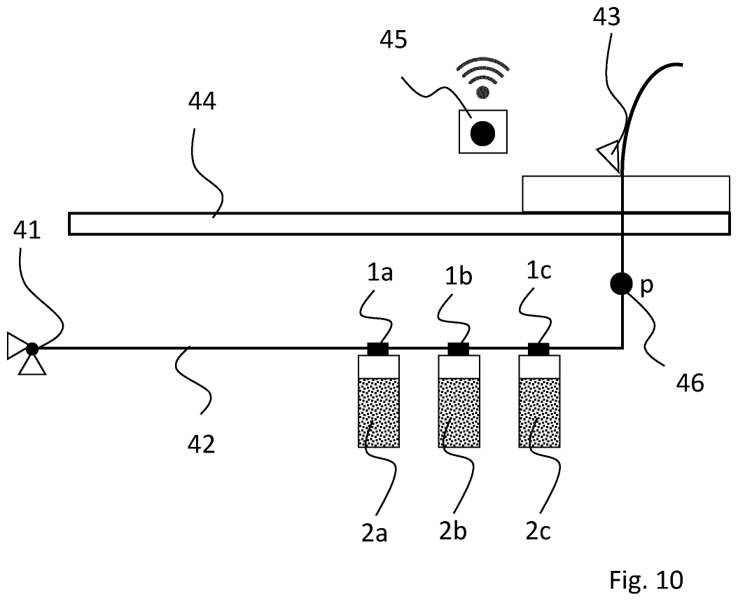

FIG. 10 schematically illustrates an installation system 40 according to an exemplary embodiment.

The installation system comprises an on-site connection 41, from which the water flows via the pipe 42 to a tap 43, such as a water faucet.

The system is designed as an under-counter system. In this view, the filter heads 1a-1c are located below a worktop 44.

The respective mounting brackets and fittings are not shown.

In this exemplary embodiment, the filter heads 1a-1c are connected in series, but can also be connected in parallel.

Each respective connection head 1a, 1b, 1c has a different filter candle 2a-2c installed therein. This allows the water to be subjected to different treatment steps as desired.

The remote control 45 which is in the form of a button, for example, allows to temporarily close a bypass in at least one of the connection heads 1a-1c, so that the water temporarily flows through the filter candle 2a-2c.

The actuator (200 in FIG. 4) can thus be activated via the remote control 45. The water will then flow through one of the filter candles 2a-2c as desired. The user can then draw water from the tap 43, for example for drinking.

When the user closes the tap 43, this will be detected by the pressure sensor 46 (or by a flow meter) and the system will switch to the basic state.

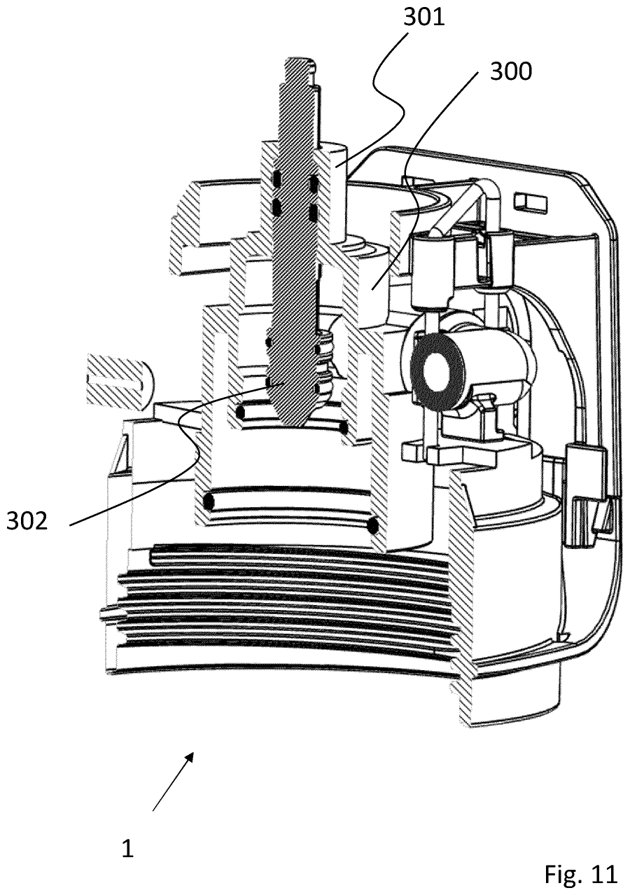

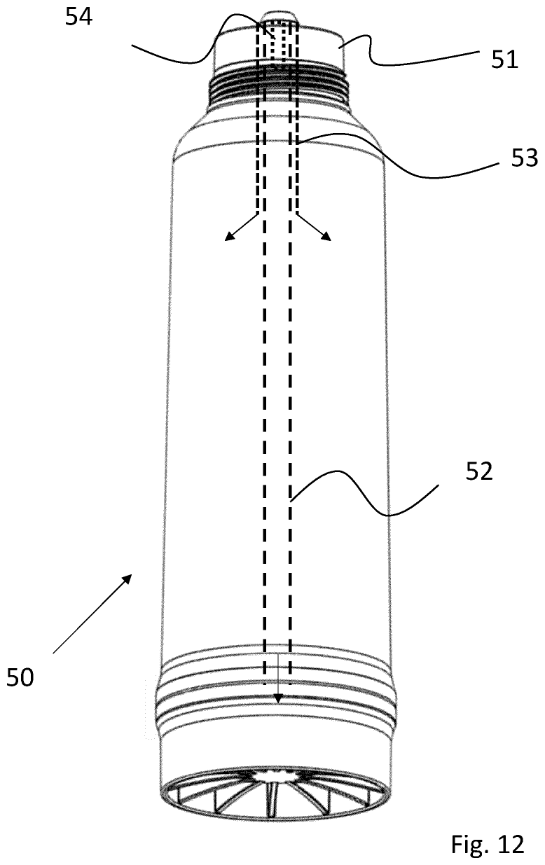

Referring to FIGS. 11 and 12, the function of the blending device 300 shall be explained in more detail.

As illustrated in FIG. 11, the blending device 300 comprises a mandrel 302 through which water can flow and which engages in the filter candle when mounted. The level of the mandrel 302 can be adjusted using a control element.

The filter candle 50 shown in FIG. 12 comprises a head portion 51 that can be coupled to the connection head.

An inner downpipe 52 and an outer downpipe 53 extend downwards from the head portion. The mandrel 302 engages in the inner downpipe 52, which has a slot 54 within the range of the mandrel 302. The slot 54 can be opened and closed selectively using the mandrel 302, i.e. the open cross section can be adjusted. This allows to adjust the flow ratio through the outer downpipe 53 and the inner downpipe 52.

Water flowing through the inner downpipe 52 reaches the bottom of the filter candle 50 and passes through all filter media, e.g. also an ion exchanger.

The outer downpipe 53 is shorter so that the water exits further up. This water is not passed through the ion exchanger, for example, but only passes through a layer of activated carbon.

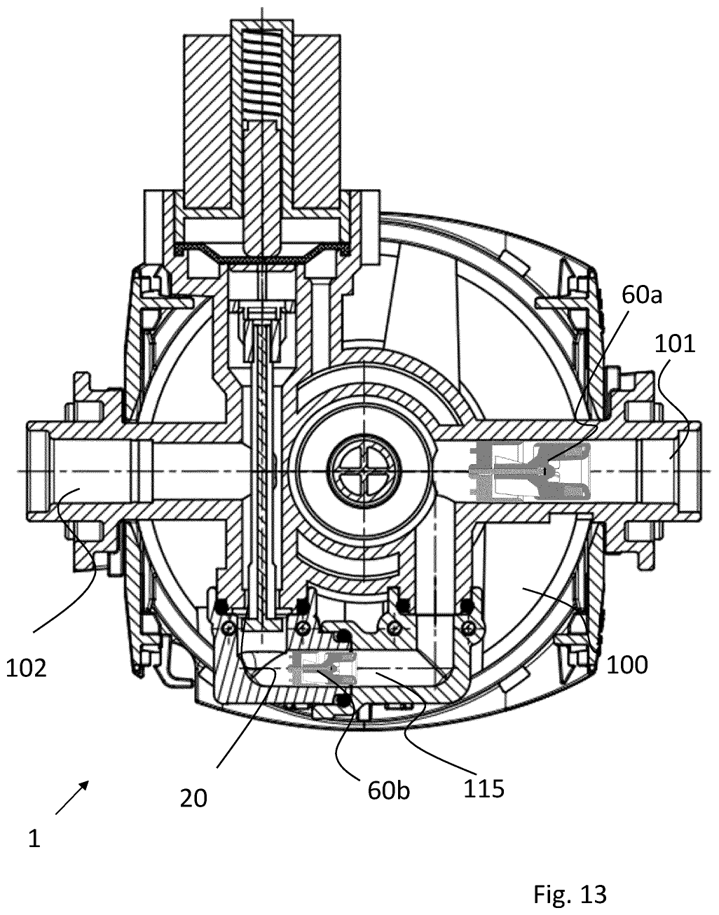

FIG. 13 is a cross-sectional view of a connection head 1 for a filter candle, which is designed according to the exemplary embodiment described above and additionally comprises flow meters 60a, 60b for determining the amount of water flowing through the filter candle.

A respective flow meter 60a, 60b is arranged in the passage coming from inlet 101 and in the bypass passage 115.

The ratio of the flow rates through the flow meters 60a, 60b can be used to calculate the amount of water flowing through the filter candle. This is preferably taken into account for calculating the service life of the filter candle.

Each of the flow meters 60a, 60b is installed inside a pipe section.

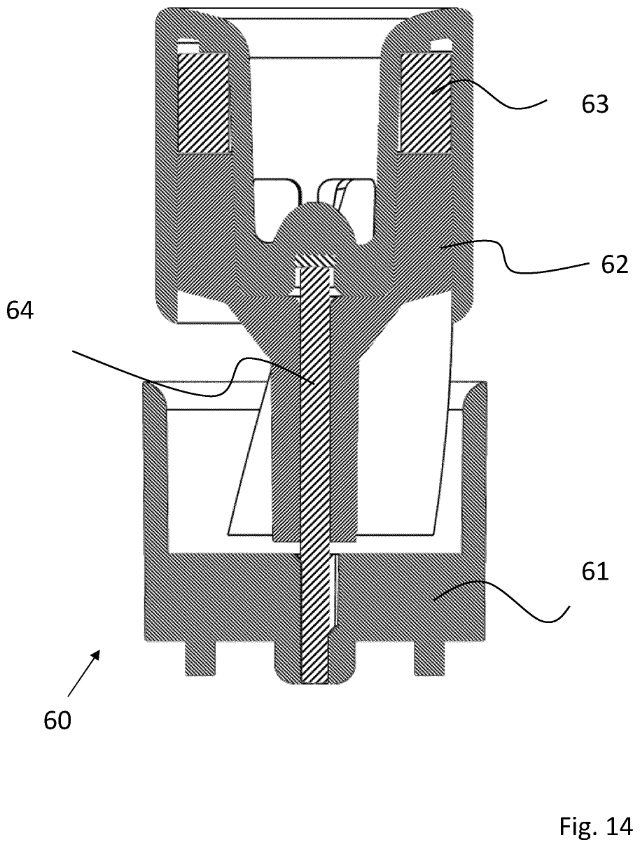

FIG. 14 shows a longitudinal sectional view of such a flow meter 60.

The flow meter 60 comprises an insert 61 which is placed in the pipe section, e.g. the bypass.

An impeller 62 is mounted on the insert 61 on an axially extending shaft 64. The flow passes axially through the impeller 62. This makes it possible to provide an impeller 62 with a small diameter, which starts up easily and exhibits low flow resistance.

The impeller 62 comprises a ferromagnetic component, in particular a magnet 63. The magnet 63 can be in the form of a ring magnet.

A sensor, e.g. a receiver coil, may be placed on or in the housing of the connection head, which allows to detect, across the pipe wall, the rotational speed of the impeller 62 and thus the flow rate.

The disclosure has made it possible to easily integrate a bypass into the connection head of a filter candle.

### LIST OF REFERENCE NUMERALS

1 Connection head
10 Diaphragm
11 Guide
12 Spacer
20 Check valve
21 Rod
22 End cap
23 Cover
24 Passage
30 Connecting piece
31 Connecting piece
40 Installation system
41 Connection
42 Pipe
43 Tap
44 Worktop
45 Remote control
46 Pressure sensor (or flow meter)
50 Filter candle
51 Head portion
52 Downpipe
53 Downpipe
54 Slot
60 Flow meter
61 Insert
62 Impeller
63 Magnet
64 Shaft
100 Housing
101 Inlet
102 Outlet
103 Connection portion
104 Mounting portion
105 Thread
106 Outlet to filter candle
107 Inlet from filter candle, annular passage
108 Connection portion
109 Passage (check valve)
110 Seat (diaphragm)
111 Passage (from 107)
112 Chamber (diaphragm)
113 Chamber (end cap)
114 Seat (check valve)
115 Passage to check valve, bypass passage
200 Actuator
201 Housing
202 Plunger
203 Spring
300 Blending device
301 Control element
302 Mandrel

1.-14. (canceled)

15. A connection head for a filter candle, comprising:
a housing having an inlet and an outlet; and
a connection portion for the filter candle,
wherein a bypass is provided inside the housing,
wherein the bypass can be opened and closed by an actuator, and
wherein the actuator extends into the housing.

16. The connection head as in claim 15, wherein the actuator is a magnetic actuator.

17. The connection head as in claim 15,
wherein, when the actuator is actuated, a check valve operative to close the bypass is releases so as to close.

18. The connection head as in claim 15, further comprising
a valve for the bypass, and
a further valve in a flow path through the filter candle,
wherein the valve and the further valve are coupled to one another and are both switched by the actuator.

19. The connection head as in claim 15,
wherein the actuator releases a diaphragm valve when actuated.

20. The connection head as in claim 19,
further comprising an adjustable blending device.

21. The connection head as in claim 20,
wherein the adjustable blending device is adapted such that the adjustable blending device is operable to adjust a ratio of volume flows of partial flows that flow into the filter candle via two different paths.

22. The connection head as in claim 17,
wherein the actuator comprises an actuator housing which is arranged on a seat provided laterally on the housing of the connection head;
and/or wherein the actuator actuates a diaphragm valve via a plunger that is movable against a spring load;
and/or wherein the bypass and/or the actuator and/or the check valve are located at a level of the inlet and the outlet.

23. An installation system comprising at least one connection head as in claim 15.

24. An installation system comprising
at least two connection heads as in claim 15,
wherein a first of the at least two connection heads comprises a first filter candle, and
wherein a second of the at least two connection heads comprises a second filter candle, and
wherein the first filter candles contains a different water treatment medium than the second filter candle.

25. The installation system as in claim 23,
further comprising a remote control for switching the actuator of the at least one connection head.

26. The installation system of claim 25,
wherein taking into account the switching of the actuator allows to calculate a service life of the filter candle.

27. A connection head for a filter candle, comprising:
a housing having an inlet and an outlet;
a connection portion for the filter candle; and
a bypass provided in the housing,
wherein a respective flow meter is arranged in a bypass passage and in at least one of an inlet passage and outlet passage.

28. The installation system of claim 24,
wherein, when an extraction tap is closed, the system switches to a basic state in which water flows through the bypass.

29. The installation system of claim 28,
wherein the system comprises a pressure sensor or a flow meter and switches to the basic state when pressure increases.
